(19) United States
(12) Patent Application Publication
(10) Pub. No.: US 2006/0208033 A1
(43) Pub. Date: Sep. 21, 2006

(54) Apparatus and method for connecting coated wires

(76) Inventor: Curtis L. Welter, Englewood, FL (US)

Correspondence Address: Charles J. Prescott, P.A.;Suite 115, 2033 Wood Street, Sarasota, FL, 34237, US

(21) Appl. No.: 11/085,283

(22) Filed: Mar. 21, 2005

(51) Int. Cl. B23K 20/10; B23K 1/06

(52) U.S. Cl. 228/110.1; 228/1.1

(57) ABSTRACT

An apparatus and method of connecting a covered wire to a wire terminal which incorporates ultrasonic and resistance welding in sequence. The method includes (a) positioning the wire terminal against an anvil; (b) positioning the covered wire against the terminal; (c) positioning a tip of an ultrasonic welder in clamped engagement with the wire terminal and the covered wire together against the anvil; (d) ultrasonically vibrating the tip for a time sufficient for the covering against the terminal to be displaced and electrical contact established between the tip and the anvil through the wire and the terminal; and (e) applying sufficient electric current between the tip and the anvil to resistance weld the wire and the terminal together.

### CROSS-REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates generally to apparatus and methods for connecting a coated wire with another metallic object such as another coated wire or wire terminal, and more particularly to the utilization of ultrasonic resistance welding in connecting a covered wire with a conductive wire terminal and the like.

2. Description of Related Art

In production processes of attaching small covered or coated or jacketed wire having an inner conductive solid or stranded core or center to another object such as a similar covered wire, a wire terminal or other conductive object, the technique of ultrasonic welding is frequently utilized. In this process, pressure is applied against the covered wire atop or adjacent to the conductive object to which the wire is to be permanently attached. The tip of an ultrasonic welder is then vibrated at high ultrasonic frequencies which produces sufficient abrasive action between the covered wire and the conductive object to produce heat and abrasive force which displaces the non-conductive covering around the metallic wire core or center whereupon further ultrasonic movement produces heat sufficient to create a permanent weld bond therebetween.

However, in applying the ultrasonic welding technique to small wires and leads, damage can occur to the wire itself during the process which will then lead to premature wire failure or increased resistance as a result of the loss of some of the inner core strands being separated.

Another technique utilized to connect small covered wire to other conductive objects is the utilization of heat which will generate sufficient thermal energy to melt the wire covering and will then effect a permanent connection in the form of a weld.

Still another technique to effect the welding of small covered wires and other conductive objects such as wire terminals is the utilization of resistive welding. However, the wire covering has sufficient resistivity to render this process alone to be inadequate in and of its own to effects such welds commercially, requiring removal or stripping away of the portion of covering over the wire conductor before the resistance weld to the conductive terminal can be made.

A number of prior art patents as listed below disclose the independent processes of ultrasonic welding, heat welding and resistive welding of covered wire to a conductive object such as a wire terminal, but none appear to disclose a combination of ultrasonic equipment to first displace or remove the wire covering and then to utilize resistive welding to effect a permanent resistive weld between the conductive wire core and the wire terminal or other conductive object.
U.S. Pat. No. 6,226,865 to Tanikawa, et al.
U.S. Pat. No. 6,291,771 to Tanikawa, et al.
U.S. Pat. No. 6,381,840 to Ide
U.S. Pat. No. 6,588,646 to Loprire
U.S. Pat. No. 6,671,952 to Ono
U.S. Pat. No. 6,643,926 to Sakaguchi, et al.
   Ultrasonic Shear Welding Method

In utilizing ultrasonic welding, the coated wire is first placed on the terminal. As the terminal rests upon a fixed “anvil”, an ultrasonic tip descends, pressing on the wire. The wire is “scrubbed” into the terminal forming an ultrasonic weld and low resistance connection.

However, ultrasonically cleaned wire cannot be welded to “tinned” (solder coated) terminals. Resistance spot welding often uses “tinned” terminals to enhance welding capabilities as well as having “tinned” terminals enhances future soldering processes of the completed product.

Resistance Welding or Solder Reflow Method

In utilizing resistance welding, the coated wire is first placed on the terminal as the terminal rests upon a fixed lower electrode. The upper electrode tip descends, pressing on the wire. The pressure deforms the wire and causes a crack or failure in the insulating coating thus forming an electrical path from the upper electrode to the lower electrode through the wire and terminal. Electrical energy is passed through the parts. Not enough to weld, but enough heat energy to further destroy the insulating coating in the area. When the resistance of the insulation has been greatly reduces, the energy is increased to the point of melting the wire and connector at the interface to form a resistance spot weld or to remelt the solder on the connector to reflow and solder the wire to the connector.

However, small diameter wires have a disproportionally thick insulation coating. Insulation coating thickness is determined by voltage of end use of wire product. Wire thickness is determined by amperage of end use of wire product. The ultrasonic “scrubbing” action to clean the wire fatigues the wire. When the violent “scrubbing” action of ultrasonic welding occurs, thin wires previously fatigued break off. Thin wires have an insulating coating too thick to crack or break under pressure which would create the initial electrical path for heating and further insulation removal by heat.

In general, the invention is designed to resolve virtually all issues associated with connecting any coated metallic object or plurality of coated metallic objects to another or plurality of other coated or uncoated metallic objects by first employing ultrasonic shear action for covering removal and cleaning purposes and then employing resistance spot welding or heating for solder reflow to join the parts mechanically and/or electrically. The present invention overcomes these drawbacks as follows:

a) Once ultrasonic shear action cleans wire and good electrical contact is established, the ultrasonic action is terminated and resistance spot welding is immediately employed in the same fixture, and machine.

Thicker wires end up with oxidation coating from heating to remove the insulation and cannot be soldered without the addition of “flux” to reclean the oxidized surface of the wire.

(b) Ultrasonic shear action cleans wire with low heat so oxidation does not occur. Ultrasonic shear action cleans the wire surface to reflow solder onto surface without “flux” additive that has to be cleaned off later.

### BRIEF SUMMARY OF THE INVENTION

This invention is directed to an apparatus and method of connecting a covered wire to a wire terminal. The method includes (a) positioning the wire terminal against an anvil; (b) positioning the covered wire against the terminal; (c) positioning a tip of an ultrasonic welder in clamped engagement with the wire terminal and the covered wire together against the anvil; (d) ultrasonically vibrating the tip only for a time sufficient for the covering against the terminal to be displaced and electrical contact established between the tip and the anvil through the wire and the terminal; and (e) applying sufficient electrical energy between the tip and the anvil to resistance weld the wire and the terminal together.

It is therefore an object of this invention to incorporate both ultrasonic and resistive welding techniques to produce stronger weldments between thin covered wire and conductive objects such as wire terminals and other covered wire.

Still another object of this invention is the utilization of ultrasonic-resistance welding techniques in sequential combination to effect permanent weldments between covered wire and conductive wire terminals or other conductive objects.

Yet another object of this invention is to utilize existing equipment used for ultrasonic welding and for resistive-type welding in a sequentially controlled manner to effect ultrasonic-resistive welding.

In accordance with these and other objects which will become apparent hereinafter, the instant invention will now be described with reference to the accompanying drawings.

### BRIEF DESCRIPTION OF THE SEVERAL VIEWS OF THE DRAWING(S)

FIG. 1 is a bock diagram of the present invention.

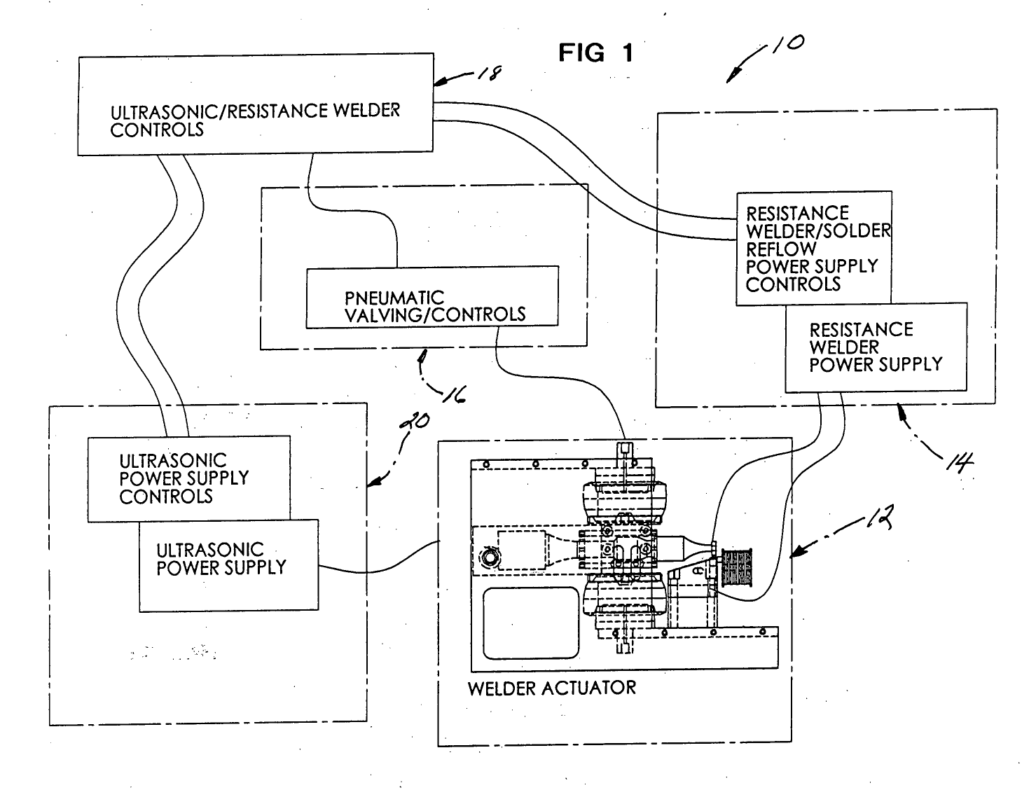

FIG. 2 is a schematic view of the improved ultrasonic welding apparatus of the present invention.

FIG. 3 is an alternate embodiment of FIG. 2.

FIGS. 4a to 4D are simplified schematic views of the sequence of ultrasonic resistance welding of the present invention.

FIGS. 5a to 5d are enlargements of portions of FIGS. 4a to 4D.

FIGS. 6a to 6d depict an alternate embodiment of the apparatus shown in FIGS. 5a to 5d.

### DETAILED DESCRIPTION OF THE INVENTION

Referring now to the drawings, the apparatus of the invention is there shown generally at numeral 10 and includes an improved, ultrasonic welder 12, a power supply for a resistance welding process 14, pneumatic valving/control 16 which actuates the hydraulic or pneumatic actuators 44/46 or 44′/46′ of the ultrasonic welder 12 and a power supply 20 for the ultrasonic welder 12. One new aspect of the invention relates to the ultrasonic resistance welder controls 18 which regulates the sequential utilization of ultrasonic wire cleaning and resistive welding to accomplish a stronger weldment between small coated wire or objects and conductive objects such as wire terminals and other metal objects.

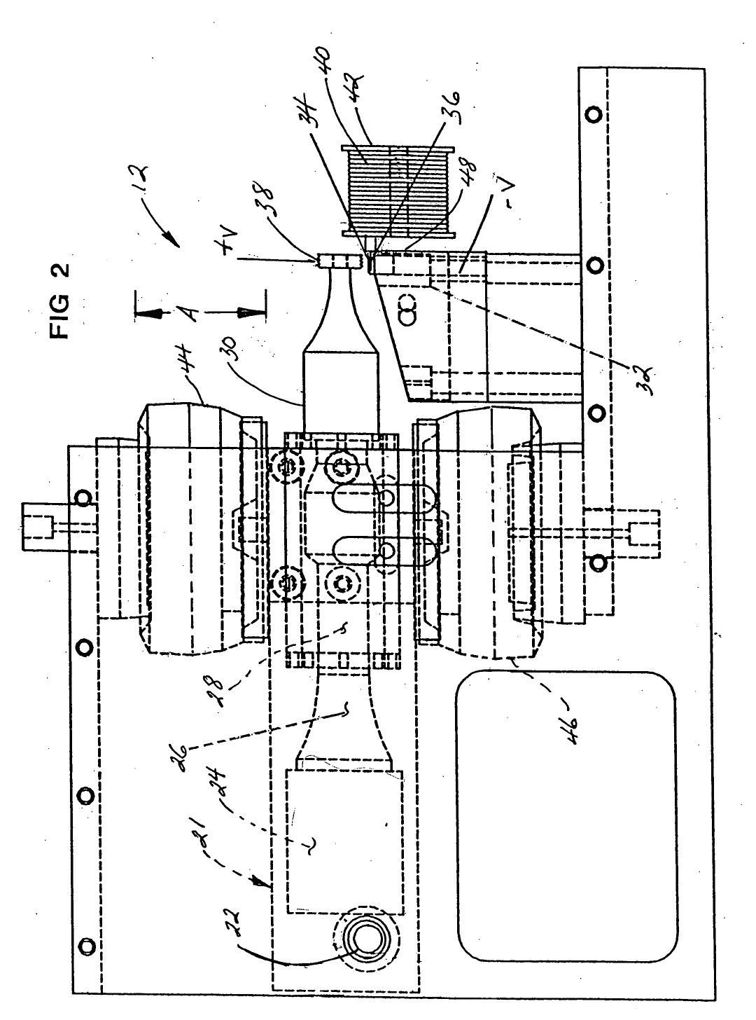

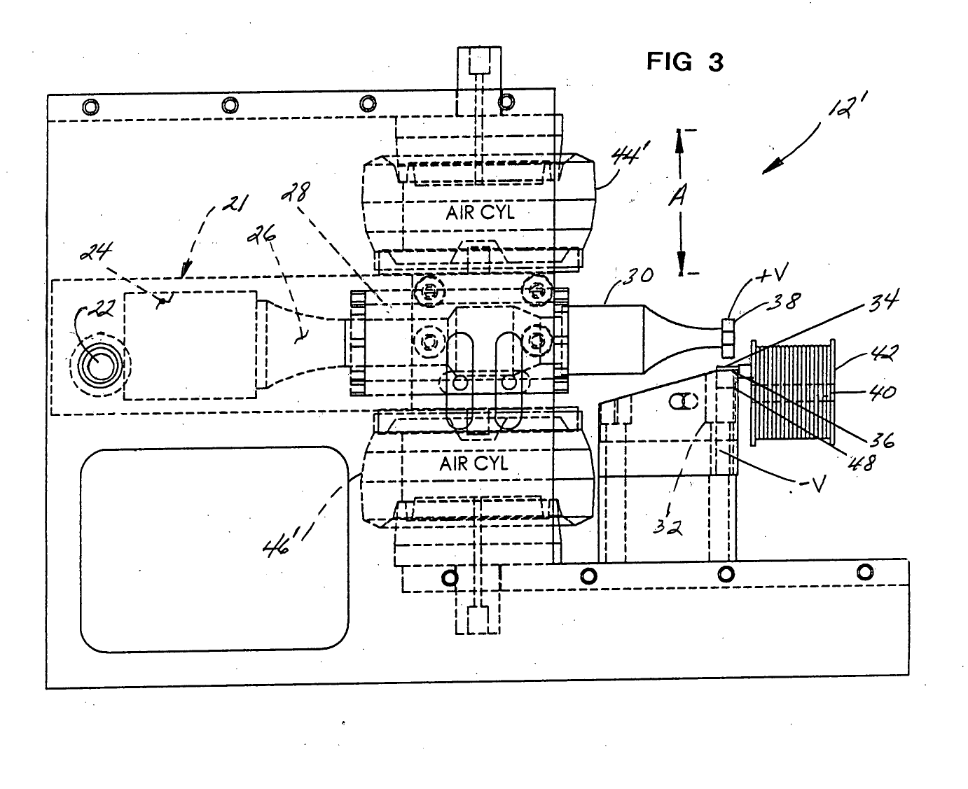

Referring to FIGS. 2 and 3, alternate embodiments of the improved ultrasonic welder are there depicted generally at numeral 12 and 12′. In FIG. 2, the ultrasonic welder 12 generally includes a carriage 21 pivotally movable about bearing 22 and including an ultrasonic converter transducer 24 having a power supply 20 associated therewith and a vibration mechanism 26, a booster 28 and an ultrasonic horn 30 having a distal tip 38 associated therewith. Hydraulic actuators 44 and 46 cause the tip 38 to move up and down generally in the direction of arrow A to apply pressure against objects in holder 54 atop an anvil 32 as described herebelow.

In FIG. 3, the alternate embodiment 12′ includes pneumatic or air cylinders 44′ and 46′ and otherwise include the same components of the improved ultrasonic welding machine 12′. Note that all other manual or power actuators causing the pivotal motion of the carriage 21 about bearing 22 are viewed as equivalent. Additionally, a spool 42 of covered wire 40 is positioned adjacent the anvil 32 so that selected lengths of the covered wire B52 are positionable as will be described herebelow in position for ultrasonic-resistance welding to a wire terminal.

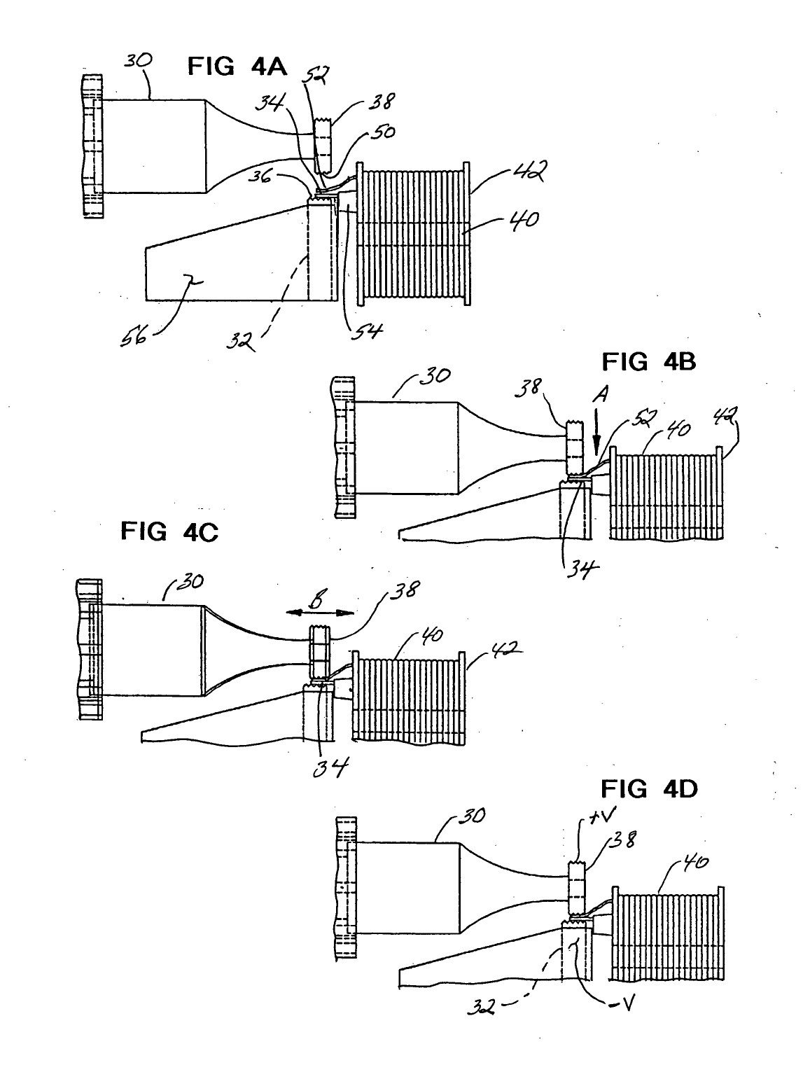

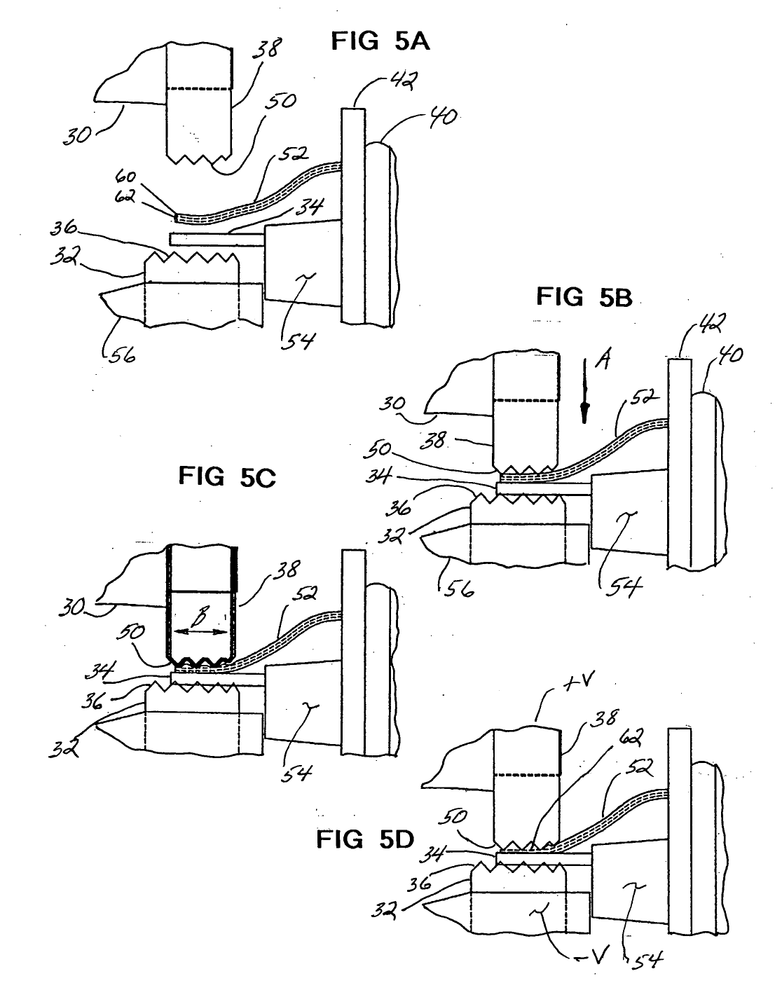

Referring now to FIGS. 4A to 4D and corresponding FIGS. 5A to 5D, the sequence of ultrasonic cleaning and resistive weldment associated with the present invention is there shown. In FIGS. 4A and 5A, the distal end of the covered wire at 52 taken from the spool 40 is positioned atop a conductive wire terminal 34 secured in holder 54 as best shown in FIG. 5A. The wire terminal 34 is positioned immediately above and against the serrated surface 36 of anvil 32 of anvil support 56.

Tip 38, having serrations 50 and supported by horn 30, is initially positioned spaced above the anvil 32. Once the covered wire 52, having a non-conductive outer sheathing or covering 60 and an inner conductive core 62 formed of solid or stranded metallic wire such as copper, is positioned directly above the wire terminal 34, the horn 30 and tip 38 are moved downwardly in the direction of arrow A in FIGS. 4B and 5B. A controlled amount of pressure as implemented by actuators 44 or 44′ and 46 or 46′ is then applied to slightly squeeze the covered wire 52 and the wire terminal 34 together between serrated surfaces 36 and 50.

In FIGS. 4C and 5C, the ultrasonic scrubbing action produced by the ultrasonic machine 12 or 12′ is then energized to induce an ultrasonic vibration into the tip 38 in the direction of arrow B. In a well known fashion, the abrading action of this ultrasonic movement of tip 38 against the covered wire 52 displaces the non-conductive covering to expose the conductive wire 62 to contact with serrations 50 and wire terminal 34. The wire terminal 34 is already in electrical contact against the serrated surface 36 so that, as soon as electrical contact is made between the tip 38 and anvil 32 by a conventional continuity sensor (not shown), the ultrasonic motion of tip 38 in the direction of arrow B is terminated and, as shown in FIGS. 4D and 5D, an appropriate voltage and current at +V and −V are applied between the tip 38 and the anvil 32 to effect the resistance weld between the conductor 62 and the conductive terminal 34.

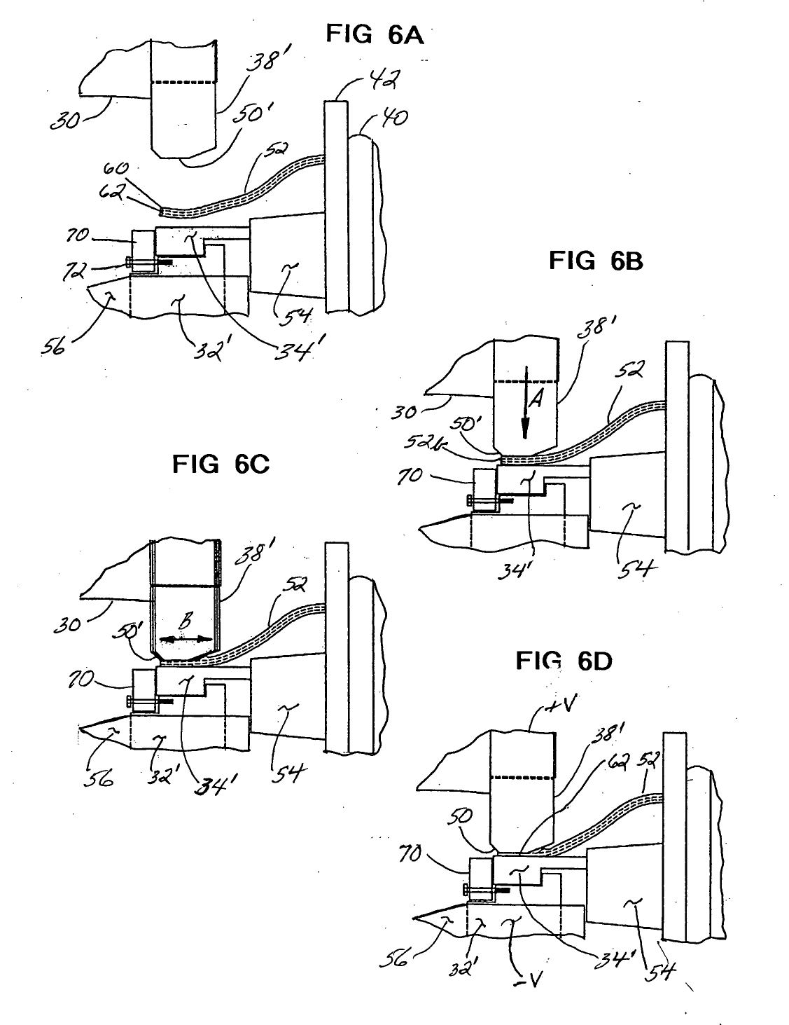

Referring now to FIGS. 6A to 6D, an alternate embodiment of the tip 38′ and anvil 32′ are there shown. In this embodiment of the invention, the tip 38′ has a smooth surface 50′ while the conductive wire terminal 34′ of a slightly different configuration is adapted to be clamped between the anvil 32′ and a jaw 70 tightenable by screw 72. Otherwise, the same sequence of events as previously described with respect to FIGS. 5A to 5D is applied. However, in step 6D, the application of sufficient electrical energy (+v/=v) between the tip 38′ and anvil 32′ is utilized after the ultrasonic removal of the covering 60 from the conductive inner wire core 62 to effect the resistive weed between wire conductor 62 and terminal 34′.

It should be clear that the benefit afforded by the present invention, while utilizing the important beneficial effects of ultrasonic scrubbing removal of the non-conductive covering from a covered wire as previously described is incorporated, no detrimental effect of continuing the ultrasonic weldment process is realized. Rather, at the point where the non-conductive wire covering has been ultrasonically removed, further ultrasonic vibration is terminated and the resistive weldment form is then accomplished to produce both a permanent resistive weld between the inner conductor of the covered wire 52 and a conductive object, e.g. terminal 34 or 34′, while avoiding harm to the conductor which typically occurs when ultrasonic welding is utilized for this entire process.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

1. A method of connecting a covered wire to a conductive wire terminal comprising the steps of:
positioning the wire terminal against an anvil;
positioning the covered wire against the terminal;
positioning a tip of an ultrasonic welder in clamped engagement with the wire terminal and covered wire together against the anvil;
actuating the ultrasonic welder for a time sufficient for a covering of the wire to be displaced and electrical contact established between the tip and the anvil through the wire and the terminal;
stopping the ultrasonic welder;
applying sufficient electrical energy between the tip and the anvil to resistance weld the wire and the terminal together.

2. A method of connecting a covered wire to a conductive wire terminal, the wire having an outer non-conductive cover and an inner conductive wire, comprising the steps of:
positioning the wire terminal against an anvil;
positioning the covered wire against the terminal;
positioning a tip of an ultrasonic welder in clamped engagement with the wire terminal and covered wire together against the anvil;
actuating the ultrasonic welder to vibrate the tip ultrasonically for a time sufficient for a covering of the wire to be displaced and electrical contact established between the tip and the anvil through the wire and the terminal;
stopping the tip vibration;
applying sufficient electric current between the tip and the anvil to resistance weld the wire and the terminal together.

3. A method of connecting a covered wire to a conductive wire terminal comprising the steps of:
clamping the wire terminal onto an anvil;
positioning the covered wire against the terminal; clamping a tip of an ultrasonic welder against the wire terminal and covered wire together and against the anvil;
ultrasonically vibrating the tip only for a time sufficient for a covering of the wire to be displaced and electrical contact established between the tip and the anvil through a conductor in the wire and the terminal;
after the ultrasonic welder is stopped, applying electric power between the tip and the anvil to resistance weld the wire conductor and the terminal together.

4. An apparatus for connecting a covered wire to a conductive wire terminal comprising:
an ultrasonic welder including a movable tip and an anvil adapted for supporting the wire terminal positioned thereagainst;
said tip clampingly engagable against a portion of a covered wire and the wire terminal together against the anvil;
a control for actuating the ultrasonic welder to vibrate the tip ultrasonically only for a time sufficient for a covering of the wire against the terminal to be displaced and electrical contact established between the tip and the anvil through a conductor of the wire and the terminal;
said control also actuating an electric power source between the tip and the anvil sufficient to resistance weld the wire conductor and the terminal together.

5. A process of ultrasonic-resistance welding a covered wire and a conductive wire terminal together comprising the steps of:
positioning the wire terminal against an anvil;
positioning the covered wire against the terminal;
positioning a tip of an ultrasonic welder in clamped engagement with the wire terminal and covered wire together against the anvil;
actuating the ultrasonic welder for a time sufficient for a covering of the wire to be displaced and electrical contact established between the tip and the anvil through the wire and the terminal;
stopping the ultrasonic welder;
applying sufficient electrical energy between the tip and the anvil to resistance weld the wire and the terminal together.
